(19) United States
(12) Patent Application Publication
(10) Pub. No.: US 2012/0244431 A1
(43) Pub. Date: Sep. 27, 2012

(54) ELECTRODE FOR NON-AQUEOUS ELECTROLYTE BATTERY, AND NON-AQUEOUS ELECTROLYTE BATTERY USING THE ELECTRODE

(75) Inventors: Yuji Tani, Sumoto-shi (JP); Kazunori Donoue, Sumoto-shi (JP)

(73) Assignee: SANYO ELECTRIC CO., LTD., Osaka (JP)

(21) Appl. No.: 13/427,079

(22) Filed: Mar. 22, 2012

(30) Foreign Application Priority Data
Mar. 23, 2011 (JP) 2011-063992

(51) Int. Cl. H01M 4/137; H01M 4/64; H01M 4/66; H01M 4/13

(52) U.S. Cl. 429/211

(57) ABSTRACT

An electrode for a non-aqueous electrolyte battery has a current collector; and an electrode active material layer formed on the current collector, the electrode active material layer containing an electrode active material and carboxymethylcellulose. The weight of the electrode active material layer is at 250 g/m² to 350 g/m²; the degree of etherification of the carboxymethylcellulose is from 0.5 to 1.0; the average degree of polymerization of the CMC is from 1600 to 1800; and the amount of the carboxymethylcellulose is set at from 0.4 mass % to 0.75 mass % with respect to 100 mass % of the electrode active material.

### BACKGROUND OF THE INVENTION

1. Field of the Invention

The present invention relates to improvements in an electrode used for a non-aqueous electrolyte battery, such as a lithium-ion battery or a polymer battery, and in a non-aqueous electrolyte battery using the electrode. More particularly, the invention relates to a negative electrode for a non-aqueous electrolyte battery with high quality and excellent reliability.

2. Description of Related Art

Rapid advancements in size and weight reductions of mobile information terminal devices such as mobile telephones, notebook computers, and PDAs in recent years have created demands for batteries with higher capacity and lower cost as the drive power source for such devices. With their high energy density and high capacity, non-aqueous electrolyte batteries that perform charge and discharge by transferring lithium ions between the positive and negative electrodes have been widely used as the power source for such mobile information terminal devices. Moreover, the mobile information terminal devices tend to consume more and more power, as the functions of the devices, such as video playing functions and gaming functions, become more complex and diverse. Accordingly, there is a strong demand for a non-aqueous electrolyte secondary battery with lower costs as well as higher capacity and higher performance such that it can enable the devices to operate for longer hours at high output power.

Conventionally, attempts have been made to increase the capacity of the non-aqueous electrolyte secondary batteries by reducing the proportion of the components in the battery can that do not relate to the electric power-generating element. These attempts have been made by reducing thickness of the components that do not relate to the power-generating element, such as battery can, separator, and current collector (aluminum foil or copper foil), by increasing the filling density of active material (i.e., improving the electrode filling density), and by increasing the coating amount of the active material in the positive electrode or the negative electrode. In addition, increasing the coating amount of the active material (i.e., performing thick coating) as described above consequently reduces the proportion of the components in the battery that do not relate to the electric power-generating element and as a result serves to reduce the cost of the battery.

However, when the thick coating is used to prepare an electrode plate as described above, cracks will form in the electrode plate after coating an electrode mixture on the electrode plate and drying it, leading to poor product quality of the electrode plate.

As disclosed in Japanese Published Unexamined Patent Application Nos. 11-67213, 2011-14262, and 2009-140637 (Patent Documents 1 to 3, respectively), various proposals have been made concerning improvements in the electrode by adding, to an electrode mixture, carboxymethylcellulose (hereinafter also referred to as “CMC”) as a polymer material that has the function to, for example, impart viscosity to the electrode mixture, so as to improve the binding performance of the active material, the uniformity of the electrode mixture layer, the quality of the coating surface, and the like.

Japanese Published Unexamined Patent Application No. 11-67213 (Patent Document 1) discloses the use of a binder agent containing CMC having a degree of etherification of 0.5 to 1 and a mean degree of polymerization of 300 to 1800 to improve the binding performance and the current collection performance of an electrode active material.

Japanese Published Unexamined Patent Application No. 2011-14262 (Patent Document 2) discloses a method of manufacturing an electrode for a non-aqueous electrolyte battery that aims at improving the uniformity of the electrode mixture layer, and it shows, as an example, the use of CMC having a degree of etherification of 0.7 and a degree of polymerization of 1700 as a thickening agent.

Japanese Published Unexamined Patent Application No. 2009-140637 (Patent Document 3) discloses that the surface quality of the electrode plate after coating and drying is improved by appropriately selecting CMC, and it shows, as a comparative example, the use of CMC having a degree of etherification of 0.7 and a degree of polymerization of 1700.

### CITATION LIST

[Patent Document 1] Japanese Published Unexamined Patent Application No. 11-67213
[Patent Document 2] Japanese Published Unexamined Patent Application No. 2011-14262
[Patent Document 3] Japanese Published Unexamined Patent Application No. 2009-140637

Nevertheless, none of the foregoing Patent Documents 1 through 3 shows a solution to the problem of degradation in the product quality of the electrode plate prepared by the thick coating as described above. For example, Patent Document 1 shows that the composition for an electrode is coated at a thickness of 200 g/m² and Patent Document 3 shows that the coating amount of the composition for an active material layer is set at about 240 g/m²; however, these amounts of coating are far from the level of thick coating, so it is believed that these documents do not need to consider the problem of the cracks and the resulting quality degradation in the electrode plate. On the other hand, Patent Document 1 also describes that the composition for an electrode is coated with a thickness of 400 g/m², and Patent Document 2 describes that a 160 μm-thick electrode mixture layer (negative electrode mixture layer) was formed on both sides of an electrode. Assuming that the density of the negative electrode active material layer is 1.2 g/m³, the coating amount (formation amount) of the just-mentioned negative electrode active material layer is believed to be 384 g/m². When the coating amount (formation amount) of active material layer is excessively large as described above, it is feared that various problems arise that, for example, the adhesion with the electrode plate becomes poor, and the binder in the electrode plate exists unevenly since the drying of the active material is difficult. That is, the coating amounts described in Patent Documents 1 and 2, 400 g/m² and 384 g/m², respectively, are too great and therefore fall outside the appropriate range of the thick coating of electrode active material.

### BRIEF SUMMARY OF THE INVENTION

In view of the foregoing and other problems, it is an object of the present invention to provide an electrode for a non-aqueous electrolyte battery in which, even when an electrode plate is prepared by coating an electrode mixture thick, cracks and the like do not form easily in the electrode plate during drying of the coating, so that a good product quality of the electrode plate can be maintained, and to provide a non-aqueous electrolyte battery having the just-mentioned electrode.

In order to accomplish the foregoing and other objects, the present invention provides an electrode for a non-aqueous electrolyte battery, comprising:

a current collector; and an electrode active material layer formed on the current collector, the electrode active material layer containing an electrode active material and carboxymethylcellulose, wherein:

the electrode active material layer has a weight of from 250 g/m² to 350 g/m²;

the carboxymethylcellulose has a degree of etherification of from 0.5 to 1.0 and an average degree of polymerization of from 1600 to 1800; and

the electrode active material layer contains the carboxymethylcellulose in an amount of from 0.4 mass % to 0.75 mass % with respect to 100 mass % of the electrode active material.

The present invention makes it possible to obtain an electrode for a non-aqueous electrolyte battery in which, even when an electrode plate is prepared by coating an electrode mixture thick, cracks and the like do not form easily in the electrode plate during drying of the coating, so that a good product quality of the electrode plate can be maintained. The invention also makes it possible to obtain a non-aqueous electrolyte battery that can achieve high capacity and low cost by reducing the components effectively through by thick coating of electrode mixture without degrading the battery performance.

### BRIEF DESCRIPTION OF THE DRAWING

FIG. 1 is a perspective view of a stack type battery according to one embodiment of the present invention.

### DETAILED DESCRIPTION OF THE INVENTION

An electrode for a non-aqueous electrolyte battery of the present invention comprises: a current collector; and an electrode active material layer formed on the current collector, the electrode active material layer containing an electrode active material and carboxymethylcellulose, wherein: the electrode active material layer has a weight of from 250 g/m² to 350 g/m²; the carboxymethylcellulose has a degree of etherification of from 0.5 to 1.0 and an average degree of polymerization of from 1600 to 1800; and the electrode active material layer contains the carboxymethylcellulose in an amount of from 0.4 mass % to 0.75 mass % with respect to 100 mass % of the electrode active material.

In the present invention, the coating amount (formation amount) of the electrode mixture in the case of thick coating, i.e., the weight of the electrode active material layer, is set at from 250 g/m² to 350 g/m². When the weight of the electrode active material layer is 250 g/m² is greater, it is likely to form cracks and the like in the electrode plate in drying the coating, leading to poor product quality of the electrode plate, so the advantageous effects of the present invention are particularly significant. On the other hand, when the weight of the electrode active material layer exceeds 350 g/m², the adhesion with the electrode plate may become poor. Moreover, it is feared that it will be difficult to dry the active material sufficiently, so the binder may be present unevenly in the electrode plate. For this reason, it is desirable that the weight of the electrode active material layer be 350 g/m² or less.

It should be noted that in the present invention, the weight of the electrode active material layer refers to the total weight of the respective electrode active material layers formed on both sides of the current collector.

When coating the electrode mixture thick as described above, the electrode mixture slurry needs to have a certain level of viscosity. Accordingly, in order to provide the viscosity to the electrode mixture slurry using CMC having a degree of polymerization of less than 1600, it is necessary that the proportion of the CMC to be added should be increased with respect to the amount of the electrode active material. However, when the amount of the CMC is increased, cracks and the like tend to form easily in the electrode plate in drying the coating. On the other hand, if the degree of polymerization of the CMC exceeds 1800, the viscosity of the electrode mixture slurry will be excessively high. If the proportion of the CMC is reduced (for example, to less than 0.4 parts by weight) to keep the viscosity of the electrode mixture slurry low, the electrode active material surface is not covered sufficiently with the CMC. Note that the surface of the electrode active material should be covered with the CMC in order to inhibit aggregation of the electrode active material when adding the binder.

In contrast, in the present invention, the average degree of polymerization of CMC is restricted in the range of from 1600 to 1800. As a result, the viscosity can be provided to the electrode mixture slurry without increasing the amount of the CMC excessively, which can increase the likelihood of formation of cracks and the like in the electrode plate. At the same time, the viscosity of the electrode mixture slurry can be set within an appropriate range, not too high, without reducing the amount of the CMC excessively, which may cause the CMC to cover the electrode active material surface insufficiently.

Moreover, in the present invention, the degree of etherification of the CMC is set to be from 0.5 to 1.0, as described above. The CMC having a degree of etherification of less than 0.5 is insoluble in water and therefore not suitable for use. On the other hand, the surface of the electrode active material needs to be covered by the CMC as described above in order to inhibit the aggregation in adding the binder. However, if the CMC has a degree of etherification of higher than 1.0, the CMC does not adhere to the surface of the electrode active material surface sufficiently, and consequently, the covering of the electrode active material surface becomes insufficient, making it difficult to obtain a stable electrode mixture slurry.

In addition, in the present invention, the content of the CMC in the electrode active material layer is set at from 0.4 mass % to 0.75 mass % with respect to 100 mass % of the electrode active material, as described above. If the content of the CMC is set higher than 0.75 mass % with the CMC having a degree of polymerization within the specified range (e.g., from 1600 to 1800), the CMC remaining in the electrode mixture slurry is apt to aggregate in the drying of the electrode active material, causing the electrode plate to form cracks. On the other hand, if the content is set at less than 0.4 mass %, the covering of the electrode active material surface will become insufficient and it becomes difficult to obtain a stable electrode mixture slurry because the amount of the CMC is too small.

As described above, the configuration of the present invention makes it possible to prevent formation of cracks and the like in the electrode plate in the case of coating the electrode mixture thick, and to keep a good product quality of the electrode plate.

The carboxymethylcellulose (CMC) used in the present invention may have the structure represented by the following Chemical Formula (1).

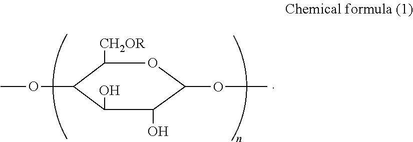

(In the above chemical formula (1), R represents a group selected from —H or —CH₂COOX, where X represents a group selected from Na, NH₄, Ca, K, Al, Mg, and H, and when there are a plurality of R or a plurality of X, they may be the same or different. In addition, n is an integer from 1600 to 1800.)

The chemical structure represented by the above chemical formula (1) is one in which a carboxymethyl group is bonded to a hydroxy group of cellulose through an ether linkage. Generally, CMC refers to its sodium salt, but there are also its ammonium salt and its calcium salt. The CMC used in the present invention may be any of them, but its ammonium salt and its sodium salt are preferable.

It is desirable that the electrode active material layer contain the carboxymethylcellulose in an amount of from 0.4 mass % to 0.625 mass % with respect to 100 mass % of the electrode active material.

If the content of the CMC is set at less than 4 mass % with the CMC having a degree of polymerization within the specified range (e.g., from 1600 to 1800), the covering of the electrode active material surface will be insufficient because the amount of the CMC is too small as described above, and it will be difficult to obtain a stable electrode mixture slurry. On the other hand, if the content is set at higher than 0.625 mass %, a slight number of voids may form in the electrode active material layer, as shown in the later-described present invention battery A4 (Example 4) in Evaluation Test 4.

It is desirable that the electrode active material be a negative electrode active material.

Although the electrode active material may be a positive electrode active material, the advantageous effects of the present invention are particularly significant when the electrode active material is a negative electrode active material.

Usable examples of the negative electrode active material include carbon materials, tin oxide, silicon, and silicon oxide.

It is desirable that the electrode active material be a carbon material.

For example, when the electrode active material is a negative electrode active material, the carbon materials that absorb and release lithium ions can be suitably used since they are considered advantageous overall in various characteristics, such as capacity, initial efficiency, and cycle life, among the examples of the negative electrode materials listed above. Moreover, suitable examples of the carbon materials include graphite such as natural graphite and artificial graphite, graphitized pitch-based carbon fiber, hard carbon, soft carbon, pyrocarbon, glassy carbon, sintered substance of organic polymer compound, carbon fiber, active carbon, and coke.

It is desirable that the electrode active material be graphite.

Among the carbon materials shown above, it is particularly desirable to use a graphite-based carbonaceous material in terms of its high charge-discharge efficiency in the early stage of cycle life, and the flatness of the potential.

It is desirable that the electrode active material layer contain a binder agent other than CMC, such as styrene-butadiene rubber (hereinafter also referred to as “SBR”). This binder agent shows more effective in ensuring electrode flexibility rather than adhesion strength. Therefore, in order to ensure such a level of flexibility that the problem of peeling-off or the like of the electrode active material does not arise in the manufacturing process of the battery, it is preferable that the amount of the binder agent other than the CMC be from 0.5 mass % to 1.5 mass % when the amount of the electrode active material is 100 mass. When the amount of the binder agent other than the CMC is within the range of from 0.5 mass % to 1.5 mass %, an electrode plate having excellent flexibility and excellent battery performance can be obtained.

It is desirable that the current collector be a metal foil.

The current collector may be, for example, a net-like (mesh) current collector. However, the metal foil current collector is inferior in adhesion capability with the electrode active material to the net-like current collector, and the electrode active material of the present invention can improve the adhesion capability. Therefore, the advantageous effects thereof are particularly noticeable when the current collector is a metal foil

In order to accomplish the foregoing and other objects, the present invention also provides a non-aqueous electrolyte battery comprising the above-described electrode for a non-aqueous electrolyte battery.

The above-described configuration of the present invention makes it possible to prevent formation of cracks and the like in the electrode plate when the electrode mixture is coated thick so as to maintain a good product quality of the electrode plate. As a result, the invention enables increasing the coating amount of the active material i.e., performing thick coating, and consequently reducing the proportion of the components in the battery that do not relate to the electric power-generating element, without impairing the battery performance, and thereby allows the battery to have higher capacity and achieve lower cost.

Hereinbelow, the present invention is described in further detail based on certain embodiments and examples thereof. It should be construed, however, that the present invention is not limited to the following embodiments and examples, and various changes and modifications are possible without departing from the scope of the invention.

### Preparation of Negative Electrode

Using a Robomix mixer (T.K. Robomix) made by Primix Corp, a later-specified amount of CMC was dissolved in deionized water. Next, artificial graphite (average particle size 21 μm, surface area 4.0 m²/g) as the negative electrode active material and the CMC aqueous solution were mixed using a Hivis Mix mixer (T.K. Hivis Mix, 2P-1) made by Primix Corp. To the resultant mixture, 1 mass % of SBR and deionized water for controlling viscosity were added and mixed, whereby a negative electrode mixture slurry was obtained. Thereafter, the resultant negative electrode mixture slurry was coated onto both sides of a copper foil as the negative electrode current collector by reverse coating, and further dried at 60° C. Subsequently, the resultant article was rolled with rollers to a thickness of 0.14 mm, and thereafter, it was cut into pieces each having a width of 90 mm and a height of 90 mm, to thereby prepare negative electrodes (negative electrode plates) each having a negative electrode active material layer on both side thereof. At this point, an active material uncoated portion having a width of 30 mm and a height of 20 mm was allowed to protrude from an end of each of the negative electrodes, to form a negative electrode current collector tab.

### Determination of Degree of Etherification of CMC

From 0.5 g to 0.7 g of CMC samples were weighed accurately, and each sample was wrapped by filter paper and carbonized in a porcelain crucible. After cooling each sample, it was moved into a 500 mL beaker, and about 250 mL of water added thereto. Further, 35 mL of 0.05 mol/L sulfuric acid was added thereto, and boiled for 30 minutes. After cooling the solution, a phenolphthalein indicator was added to the cooled solution, and the excessive acid was back titrated with 0.1 mol/L potassium hydroxide. From the results, a substitution degree of the CMC to ether was determined according to the following equations (1) and (2).

A=(af−bf)/Sample(g)−Alkalinity (I)

Degree of etherification=(162×A)/(10,000−80A) (II)

Parameters in the above equations (I) and (II) are as follows:

A: Amount (mL) of 0.05 mol/L sulfuric acid consumed by the bonded alkali per 1 g of sample

a: Amount (mL) of 0.05 mol/L sulfuric acid used

f: Titer of 0.05 mol/L sulfuric acid

b: Titration amount (mL) of 0.1 mol/L potassium hydroxide

### Determination of Degree of Polymerization of CMC

The average degree of polymerization of CMC was determined by a value using a viscometry method. A limiting viscosity η was determined by a Ubbelohde viscometer using 0.1N-NaCl as the solvent, and the average degree of polymerization was calculated from the following equation (III).

{η}0.1-NaCl=16.6Km×P (III)

In the equation (III), Km is a constant and P is the average degree of polymerization.

### Preparation of Positive Electrode

90 mass % of LiCoO₂ as a positive electrode active material, 5 mass % of carbon black as a conductive agent, and 5 mass % of polyvinylidene fluoride as a binder agent were mixed with an N-methyl-2-pyrrolidone (NMP) solution as a solvent to prepare a positive electrode mixture slurry. The resultant positive electrode slurry was applied onto both sides of an aluminum foil (thickness: 15 μm) serving as a positive electrode current collector. Thereafter, the material was heated to remove the solvent and compressed with rollers to a thickness of 0.18 mm. Subsequently, it was cut into pieces each having a width of 85 mm and a height of 85 mm, to prepare positive electrodes (positive electrode plates) each having a positive electrode active material layer on both sides thereof. At this point, an active material uncoated portion having a width of 30 mm and a height of 20 mm was allowed to protrude from an end of each of the positive electrodes, to form a positive electrode current collector tab.

Preparation of Pouch-Shaped Separator in which the Positive Electrode is Disposed

A positive electrode as described above was disposed between two square-shaped polypropylene (PP) separators (thickness: 30 μm) each having a width of 90 mm and a height of 94 mm. Thereafter, the three sides of the separators, other than the side from which the positive electrode current collector tab protrudes, were thermally sealed, to thereby prepare a pouch-type separator 3 in which the positive electrode was accommodated.

### Preparation of Stacked Electrode Assembly

Four sheets of the above-described pouch-type separators each containing the positive electrode and five sheets of the negative electrodes were prepared, and they were alternately stacked one on the other. At this time, negative electrode plates were placed at both stacking direction-wise ends of the stack, and insulating sheets made of polypropylene (PP) and having the same dimensions and the same shape as the separator were disposed on respective further outer sides thereof. Subsequently, the top and bottom faces of the stacked component were connected by insulating tapes for retaining its shape. Thus, a stacked electrode assembly was obtained.

### Welding of Current Collectors

A positive electrode current collector terminal made of an aluminum plate having a width of 30 mm and a thickness of 0.4 mm and a negative electrode current collector terminal made of a copper plate having a width of 30 mm and a thickness of 0.4 mm were welded respectively to the foremost ends of the positive electrode current collector tabs and the foremost ends of the negative electrode current collector tabs by ultrasonic welding.

### Placing the Electrode Assembly in Battery Case

The above-described stacked electrode assembly was inserted into a battery case formed of laminate films, which had been shaped in advance so that the stacked electrode assembly could be placed therein. Then, the three peripheral sides of the battery case, except for one of three peripheral sides other than the side in which the positive electrode current collector terminal and the negative electrode current collector terminal were placed, were thermally welded together so that only the positive electrode current collector terminal and the negative electrode current collector terminal would protrude outwardly from the battery case.

### Filling Electrolyte Solution and Sealing the Battery Case

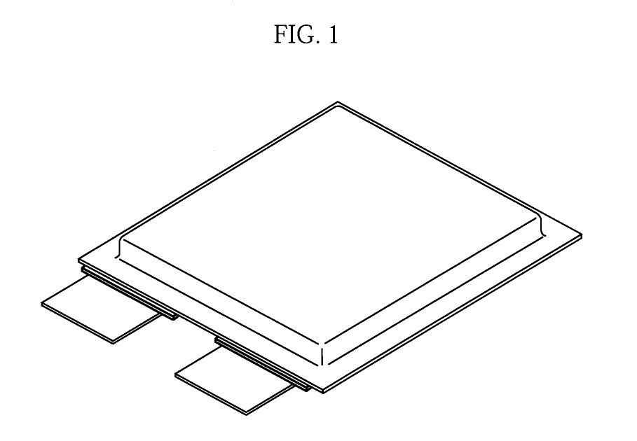

An electrolyte solution was prepared by dissolving LiPF₆ at a concentration of 1 M (mol/L) in a mixed solvent of 30:70 volume ratio of ethylene carbonate (EC) and methyl ethyl carbonate (MEC). The electrolyte solution was filled into the battery case from the one peripheral side of the battery case that was not yet thermally welded. Lastly, the one peripheral side of the battery case that had not been thermally welded was thermally welded in reduced pressure, whereby a stack type battery as shown in FIG. 1 was prepared.

Charge-Discharge Test Using the just-described stack type battery, the battery was charged at a constant voltage of 4.2 V with a maximum current of 1 A. The charging was terminated at the time when the current value dropped to 25 mA. Thereafter, the battery was discharged at a constant current of 1 A, and the discharging was finished at the time when the voltage value dropped to 2.9 V. The rest time between the charging and the discharging was 30 minutes.

### EXAMPLES

### Example 1

A stack type battery as described in the just-described embodiment was prepared as follows. A CMC having a degree of etherification of from 0.65 to 0.75 and a degree of polymerization of 1700 was used, and the amount of the CMC was set to 0.4 mass % per 100 mass % of the negative electrode active material, in preparing a negative electrode mixture slurry. 1 mass % of SBR and deionized water for controlling viscosity were added thereto, and they were mixed together. Thus, a test battery was fabricated.

The test battery fabricated in this manner is hereinafter referred to as a present invention battery A1.

### Example 2

A test battery was fabricated in the same manner as the present invention battery A1, except that the amount of the CMC was set at 0.5 mass % with respect to 100 mass % of the negative electrode active material.

The test battery fabricated in this manner is hereinafter referred to as a present invention battery A2.

### Example 3

A test battery was fabricated in the same manner as the present invention battery A1, except that the amount of the CMC was set at 0.625 mass % with respect to 100 mass % of the negative electrode active material.

The test battery fabricated in this manner is hereinafter referred to as a present invention battery A3.

### Example 4

A test battery was fabricated in the same manner as the present invention battery A1, except that the amount of the CMC was set at 0.75 mass % with respect to 100 mass % of the negative electrode active material.

The test battery fabricated in this manner is hereinafter referred to as a present invention battery A4.

### Comparative Example 1

A test battery was fabricated in the same manner as the present invention battery A1, except that the amount of the CMC was set at 0.1 mass % with respect to 100 mass % of the negative electrode active material.

The test battery fabricated in this manner is hereinafter referred to as a comparative battery R1.

### Comparative Example 2

A test battery was fabricated in the same manner as the present invention battery A1, except that the amount of the CMC was set at 1.0 mass % with respect to 100 mass % of the negative electrode active material.

The test battery fabricated in this manner is hereinafter referred to as a comparative battery R2.

### Comparative Example 3

A test battery was fabricated in the same manner as the present invention battery A1, except that the CMC used had a degree of etherification of 1.15 to 1.45 and a degree of polymerization of 1400, and that the amount of the CMC was set at 0.5 mass % with respect to 100 mass % of the negative electrode active material.

The test battery fabricated in this manner is hereinafter referred to as a comparative battery R3.

### Comparative Example 4

A test battery was fabricated in the same manner as the present invention battery A1, except that the CMC used had a degree of etherification of 0.65 to 0.75 and a degree of polymerization of 875, and that the amount of the CMC was set at 0.5 mass % with respect to 100 mass % of the negative electrode active material.

The test battery fabricated in this manner is hereinafter referred to as a comparative battery R4.

### Comparative Example 5

A test battery was fabricated in the same manner as the present invention battery A1, except that the CMC used had a degree of etherification of 0.65 to 0.75 and a degree of polymerization of 1160, and that the amount of the CMC was set at 0.5 mass % with respect to 100 mass % of the negative electrode active material.

The test battery fabricated in this manner is hereinafter referred to as a comparative battery R5.

### Comparative Example 6

A test battery was fabricated in the same manner as the present invention battery A1, except that the CMC used had a degree of etherification of 0.65 to 0.75 and a degree of polymerization of 1350, and that the amount of the CMC was set at 0.5 mass % with respect to 100 mass % of the negative electrode active material.

The test battery fabricated in this manner is hereinafter referred to as a comparative battery R6.

Evaluation Test 1 (about the Proportion of CMC Added)

The conditions of the negative electrode slurries and the product quality of the electrode plates were evaluated for the present invention batteries A1 to A4 as well as the comparative batteries R1 and R2, which had the same degree of etherification of the CMC, 0.65 to 0.75, and the same degree of polymerization, 1700, but different amounts of the CMC. The results are shown in Table 1 below. In Table 1, the conditions of the slurry were evaluated as follows; ones that were able to coat on the current collector were labelled as “good,” while ones that were unable to on the current collector were labelled as “poor.” As for the product quality of the electrode plate, ones having not streaks or pores were labelled as “good,” ones having slight pores were labelled as “fair”, and ones unable to coat were not evaluated in terms of product quality of the electrode plate.

TABLE 1

| | CMC | | | | Product |
|---|---|---|---|---|---|
| | Degree | Degree | Amount | Condition | quality of |
| Test | of | of poly- | added | of | electrode |
| battery | etherification | merization | (mass %) | slurry | plate |
| R1 | 0.65-0.75 | 1700 | 0.1 | Poor | — |
| A1 | | | 0.4 | Good | Good |
| A2 | | | 0.5 | Good | Good |
| A3 | | | 0.625 | Good | Good |
| A4 | | | 0.75 | Good | Fair |
| R2 | | | 1.0 | Poor | — |

In the evaluation test 1, the following conditions were observed.

Comparative battery R1 (the amount of the CMC was 0.1 mass % with respect to 100 mass % of the negative electrode active material):

When SBR was added, the slurry aggregated, and coating was impossible.

Comparative battery R2 (the amount of the CMC was 1.0 mass % with respect to 100 mass % of the negative electrode active material):

The CMC alone resulted in a gel form, so it was impossible to knead it with the negative electrode active material.

Present invention battery A4 (the amount of the CMC was 0.75 mass % with respect to 100 mass % of the negative electrode active material):

Although coating of the slurry (thick coating) was possible, a slight number of voids formed in the negative electrode active material layer after drying. The reason is believed to be as follows. Because the viscosity of the negative electrode slurry of this sample was higher than those of the present invention batteries A1 to A3, the air bubbles in the negative electrode slurry was inhibited from moving toward the surface of the electrode plate. As a consequence, the air bubbles were prevented from exiting from the coating film, and the air bubbles burst during the drying. As a consequence, voids were formed in the electrode plate.

Evaluation Test 2 (about the Degree of Etherification of CMC)

The conditions of the negative electrode slurries and the product quality of the electrode plates were evaluated for the comparative batteries R3 and R6, which had the same amount of the CMC, 0.5 mass % and substantially the same degree of polymerization, 1400 and 1350, respectively, but different degrees of etherification, 1.15 to 1.45 and 0.65 to 0.75, respectively. The results are shown in Table 2 below. In Table 2, the conditions of the slurry were evaluated in the same manner as in Table 1, with the labels “good” and “poor.” As for the product quality of the electrode plate, one in which streaks or voids were clearly observed was labelled as “poor.”

TABLE 2

| | CMC | | | | Product |
|---|---|---|---|---|---|
| | | Degree | Amount | | quality of |
| Test | Degree of | of poly- | added | Condition | electrode |
| battery | etherification | merization | (mass %) | of slurry | plate |
| R3 | 1.15-1.45 | 1400 | 0.5 | Poor | — |
| R6 | 0.65-0.75 | 1350 | | Good | Poor |

According to this evaluation test 2, with comparative battery R3, in which the degree of polymerization of the CMC was substantially the same as that of comparative battery R6 but the degree of etherification thereof was 1.15 to 1.45, higher than that of comparative battery R6, the slurry caused gelation when SBR was added thereto, so coating was impossible. It is believed that since a CMC having a high degree of etherification is poor in adhesion capability with carbon, the SBR directly adhered to carbon, causing the gelation of the slurry. In order to prepare a slurry suitable for thick coating by reducing the amount (concentration) of the CMC, it is necessary that the degree of etherification of the CMC be set to 1.0 or lower.

Evaluation Test 3 (about the Degree of Polymerization of CMC)

The conditions of the negative electrode slurries and the product quality of the electrode plates were evaluated for the present invention battery A2 as well as the comparative batteries R4 to R6, which had the same degree of etherification of the CMC, 0.65 to 0.75, and the same amount of the CMC, 0.5 mass %, but different degrees of polymerization. The results are shown in Table 3 below. In Table 3, the conditions of the slurry were evaluated in the same manner as in Table 1, with the labels “good” and “poor.” As for the product quality of the electrode plate, one in which streaks or voids were clearly observed was labelled as “poor,” in addition to the label “good” as in Table 1.

TABLE 3

| | CMC | | | | Product |
|---|---|---|---|---|---|
| | | Degree | Amount | | quality of |
| Test | Degree of | of poly- | added | Condition | electrode |
| battery | etherification | merization | (mass %) | of slurry | plate |
| R4 | 0.65-0.75 | 875 | 0.5 | Poor | — |
| R5 | | 1160 | | Poor | — |
| R6 | | 1350 | | Good | Poor |
| A2 | | 1700 | | Good | Good |

In the evaluation test 3, the following conditions were observed.

Comparative batteries R4 and R5 (the CMC had degrees of polymerization of 875 and 1160, respectively):

When SBR was added, the slurry aggregated, and coating was impossible.

Comparative battery R6 (the CMC had a degree of polymerization of 1350):

A desirable slurry suitable for coating was obtained.

Present invention battery A2 (the CMC had a degree of polymerization of 1700):

A desirable slurry suitable for coating was obtained, and no streak or void was observed in the electrode plate.

Evaluation Test 4 (about the Amount of Negative Electrode Active Material Layer)

The coatability of the negative electrode slurry (product quality of the electrode plate) was evaluated for the comparative battery R6 and the present invention battery A2, which had the same degree of etherification of the CMC, 0.65 to 0.75, and the same amount of the CMC, 0.5 mass %, but different degrees of polymerization, 1350 and 1700, respectively, while varying the amount, i.e., the coating amount (formation amount) of the negative electrode active material layer, step by step. The results are shown in Table 4 below. In Table 4, the samples with good slurry coatability were labelled as “good,” ones in which a slight amount of vertical streaks was observed were labelled as “fair,” and ones in which vertical streaks were clearly observed or in which cracks were observed in the mixture layer were labelled as “poor.” Note that the amount of the negative electrode active material layer refers to the total weight of the negative electrode active material layers formed on both sides of the negative electrode current collector.

TABLE 4

| | CMC | | | | | | | |
|---|---|---|---|---|---|---|---|---|
| | | | Amount | | | | | |
| | Degree of | Degree of | added | Amount of active material layer | | | | |
| | etheri- | polymer- | (mass | (g/m²) | | | | |
| | fication | ization | %) | 240 | 250 | 280 | 320 | 360 |
| R6 | 0.65-0.75 | 1350 | 0.5 | Good | Fair | Fair | Poor | Poor |
| A2 | | 1700 | | Good | Good | Good | Good | Good |

In the evaluation test 4, the following conditions were observed.

Comparative battery R6 (the CMC had a degree of polymerization of 1350):

Vertical streaks were observed when the amount of the negative electrode active material layer was 250 g/m² or greater.

Present invention battery A2 (the CMC had a degree of polymerization of 1700):

No vertical streaks was observed even when the amount of the negative electrode active material layer was 300 g/m² or greater, and the coatability (product quality of the electrode plate) was good.

The reason is believed to be as follows. In the comparative battery R6, the degree of polymerization of the CMC was lower than that of the present invention battery A2, and correspondingly the viscosity of the slurry was lower. Consequently, the water content easily evaporated more easily when drying the negative electrode active material layer, and therefore, vertical cracks formed with the samples in which the amount (the coating amount) of the negative electrode active material layer was 250 g/m² or greater.

### Battery Characteristics

Using the present invention battery A2, a charge-discharge test was carried out under the conditions as set forth in the foregoing embodiment. As a result, it was found that a designed capacity of 1000 mAh was obtained.

### Other Embodiments

(1) The configuration of the electrode for a non-aqueous electrolyte battery according to the present invention is not limited to the negative electrode for a lithium-ion battery as described in the foregoing embodiments, but may be widely applicable to other types of electrodes for non-aqueous electrolyte batteries.

(2) The positive electrode active material is not limited to lithium cobalt oxide.

Other usable materials include lithium composite oxides containing cobalt, nickel, or manganese, such as lithium cobalt-nickel-manganese composite oxide, lithium aluminum-nickel-manganese composite oxide, and lithium aluminum-nickel-cobalt composite oxide, as well as lithium nickel oxides and spinel-type lithium manganese oxides.

(3) The negative electrode active material may be other than the graphite such as natural graphite and artificial, as long as it can intercalate and deintercalate lithium ions. Examples include graphitized pitch-based carbon fiber, hard carbon, soft carbon, pyrocarbon, glassy carbon, sintered substance of organic polymer compound, carbon fiber, active carbon, coke, tin oxide, silicon, oxidized silicon, and mixtures thereof.

(4) The electrolyte is not limited to that shown in the examples above, and various other substances may be used. Examples of the lithium salt include LiBF₄, LiPF₆, LiN(SO₂CF₃)₂, LiN(SO₂C₂F₅)₂, and LiPF₆₋ₓ(CₙF₂ₙ₊₁)ₓ (wherein 1<x<6 and n=1 or 2), which may be used either alone or in combination. The concentration of the supporting salt is not particularly limited, but it is preferable that the concentration be restricted in the range of from 0.8 moles to 1.8 moles per 1 liter of the electrolyte solution. The types of the solvents are not particularly limited to EC and MEC mentioned above. Examples of preferable solvents include carbonate solvents such as propylene carbonate (PC), γ-butyrolactone (GBL), ethyl methyl carbonate (EMC), dimethyl carbonate (DMC), and diethyl carbonate (DEC). More preferable is a combination of a cyclic carbonate and a chain carbonate.

(5) The battery configuration may be other than the above-described stack type battery, and may be, for example, a spirally wound-type battery, in which an electrode assembly having positive and negative electrode plates coiled with separators interposed therebetween is enclosed in a battery case.

(6) The battery case may be other than the above-described laminate battery case formed of laminate films, and it is possible to use a battery can, for example. An example of the laminate battery case may comprise:

aluminum, an aluminum alloy, stainless steel, or the like as the metal layer;

polyethylene, polypropylene, or the like as the inner layer (inside the battery); and

nylon, polyethylene terephthalate (PET), a layered film of PET/nylon, or the like as the outer layer (outside the battery).

The present invention is suitably applied to, for example, power sources for high-power applications, such as backup power sources and power sources for the motive power incorporated in robots and electric automobiles.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. An electrode for a non-aqueous electrolyte battery, comprising:
a current collector; and an electrode active material layer formed on the current collector, the electrode active material layer containing an electrode active material and carboxymethylcellulose, wherein:
the electrode active material layer has a weight of from 250 g/m² to 350 g/m²;
the carboxymethylcellulose has a degree of etherification of from 0.5 to 1.0 and an average degree of polymerization of from 1600 to 1800; and
the electrode active material layer contains the carboxymethylcellulose in an amount of from 0.4 mass % to 0.75 mass % with respect to 100 mass % of the electrode active material.

2. The electrode for a non-aqueous electrolyte battery according to claim 1, wherein the electrode active material layer contains the carboxymethylcellulose in an amount of from 0.4 mass % to 0.625 mass % with respect to 100 mass % of the electrode active material.

3. The electrode for a non-aqueous electrolyte battery according to claim 1, wherein the electrode active material is a negative electrode active material.

4. The electrode for a non-aqueous electrolyte battery according to claim 2, wherein the electrode active material is a negative electrode active material.

5. The electrode for a non-aqueous electrolyte battery according to claim 1, wherein the electrode active material is a carbon material.

6. The electrode for a non-aqueous electrolyte battery according to claim 3, wherein the electrode active material is a carbon material.

7. The electrode for a non-aqueous electrolyte battery according to claim 4, wherein the electrode active material is a carbon material.

8. The electrode for a non-aqueous electrolyte battery according to claim 5, wherein the electrode active material is graphite.

9. The electrode for a non-aqueous electrolyte battery according to claim 6, wherein the electrode active material is graphite.

10. The electrode for a non-aqueous electrolyte battery according to claim 7, wherein the electrode active material is graphite.

11. The electrode for a non-aqueous electrolyte battery according to claim 1, wherein the current collector is a metal foil.

12. The electrode for a non-aqueous electrolyte battery according to claim 2, wherein the current collector is a metal foil.

13. The electrode for a non-aqueous electrolyte battery according to claim 3, wherein the current collector is a metal foil.

14. The electrode for a non-aqueous electrolyte battery according to claim 4, wherein the current collector is a metal foil.

15. The electrode for a non-aqueous electrolyte battery according to claim 1, wherein the electrode active material layer contains styrene-butadiene rubber.

16. The electrode for a non-aqueous electrolyte battery according to claim 2, wherein the electrode active material layer contains styrene-butadiene rubber.

17. The electrode for a non-aqueous electrolyte battery according to claim 3, wherein the electrode active material layer contains styrene-butadiene rubber.

18. The electrode for a non-aqueous electrolyte battery according to claim 4, wherein the electrode active material layer contains styrene-butadiene rubber.

19. A non-aqueous electrolyte battery comprising an electrode for a non-aqueous electrolyte battery according to claim 1.

20. A non-aqueous electrolyte battery comprising an electrode for a non-aqueous electrolyte battery according to claim 2.
